(19) United States
(12) Patent Application Publication
(10) Pub. No.: US 2010/0303262 A1
(43) Pub. Date: Dec. 2, 2010

(54) Audio Apparatus, and Method for Setting Number of Buses for Use in the Audio Apparatus

(75) Inventor: Masaaki OKABAYASHI, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-shi (JP)

(21) Appl. No.: 12/789,555

(22) Filed: May 28, 2010

(30) Foreign Application Priority Data
Jun. 1, 2009 (JP) 2009-131900

(51) Int. Cl. H04B 1/00

(52) U.S. Cl. 381/119

(57) ABSTRACT

Digital signal processor is shared for performing first mixer processing that mixes audio signals from input channels via mixing buses and then outputs resultant mixed audio signals to first output channels and second mixer processing that mixes the audio signals from the first output channels via matrix buses and then outputs resultant mixed signals to second output channels. The processor performs each of the first and second mixer processing by performing cross-point processes each for performing level control on an input signal and then adding a resultant level-controlled signal to one or more of the buses, a total number of the cross-point processes simultaneously executable by the processor being limited. Setting of the numbers of the mixing and matrix buses is controlled such that a sum of the numbers of first and second cross-point processes required for the numbers of the mixing and matrix buses set by a user respectively.

### BACKGROUND

The present invention relates an audio apparatus and method capable of setting the number of output channels of mixed audio signals.

Heretofore, there have been known digital mixers which are suited for use in concert halls etc. and in which audio signals output from a multiplicity of microphones and/or electric or electronic musical instruments are mixed together after being subjected to level and frequency characteristic adjustments. A human operator (user) operating such a digital mixer operates various panel operators or controls of the digital mixer to adjust volumes and colors of individual audio signals of musical instrument tones and singing voices to such states that appear to most suitably represent a music performance. Generally, the digital mixers include buses for mixing together audio signals supplied from input channels, and output channels for outputting mixed audio signals. Each of the input channels controls frequency characteristics, mixing level, etc. of an input audio signal and supplies the thus-controlled audio signal to the individual mixing buses, so that each of the mixing buses mixes together the supplied audio signals and outputs the resultant mixed signal to a corresponding one of the output channels. Outputs from the output channels are amplified and audibly reproduced or sounded via speakers or the like.

In the conventionally-known digital mixers, mixing processing is performed by a digital signal processing device (DSP). The mixing processing includes two major processing: adjustment processing performed by an equalizer, compressor, etc. for adjusting characteristics of audio signals; and mixer processing for mixing audio signals after controlling levels of the audio signals. Whereas the adjustment processing varies in its content depending on a model, operating mode and/or the like, the mixer processing is performed with the same content despite a model, operating mode and/or the like.

Japanese Patent Application Laid-open Publication No. 2003-255945 (hereinafter referred to as “Patent Literature 1”) discloses a digital mixer where a tone generation section for generating tones of a plurality of channels and a DSP section for performing adjustment processing are provided on a single integrated circuit. A mixer section of the disclosed digital mixer can select which audio signal should be input and to which bus an audio signal should be output, for each arithmetic channel that multiplies the signal by a coefficient. Further, for each input channel, the mixer section can designate the number of times multiplication by a coefficient is to be performed and the number of times a signal is to be mixed into buses. Furthermore, for each mixing bus, it is possible to designate signals of how many channels are to be input and from which input channels individual signals are to be input. However, with the digital mixer disclosed in Patent Literature 1, there is a need to designate, for each mixing bus, designate signals of how many channels are to be input and from which input channels individual signals are to be input, on a one-by-one basis. Thus, the disclosed digital mixer requires an enormous quantity of operation.

Japanese Patent Application Laid-open Publication No. 2008-244896 (hereinafter referred to as “Patent Literature 2”) discloses a mixing digital signal processing apparatus which can be used in mixer apparatus of various required specifications, can simplify design of a signal-processing circuit board of a mixer apparatus employing a plurality of DSPs, and can also facilitate design of processing programs to be executed by the DSPs. The disclosed digital signal processing apparatus permits designation of a mode for defining the numbers of processing channels and mixing buses to be used, repetitively performs processes for mixing input signals of the number of processing channels corresponding to the designated mode. Thus, the disclosed digital signal processing apparatus is constructed to not only detect a last step of the mixing processes for the number of processing channels corresponding to the designated mode to thereby output accumulated results at the last step, but also start new accumulation with input digital audio signals input at a next step. In this way, the mixer apparatus disclosed in Patent Literature 2 allows the combination of the numbers of processing channels and buses to be changed by designating a different mode.

Also known today is an audio apparatus which not only mixes audio signals from a plurality of input channels by means of a plurality of mixing buses to thereby provide mixed audio signals (mixed results) via a plurality of output channels, but also mixes the mixed audio signals of the output channels by means of additional buses called “matrix buses” while treating the plurality of output channels as input channels. In the mixer disclosed in Patent Literature 1, in order to set particular numbers of the mixing buses and matrix buses that fit a user's intended purpose, it is necessary to designate, on a one-by-one basis for each of the mixing buses and matrix buses, connections as to audio signals of which channels are to be input and added to audio signals of which mixing buses and connections as to audio signals of which output channels are to be input and added to audio signals of which matrix buses. Such setting operation would become enormous. Further, the mixer apparatus disclosed in Patent Literature 2, where it is possible to set predetermined numbers of mixing buses and matrix buses by designating a mode, would present the problem that the numbers of mixing buses and matrix buses can not be set at any user-desired numbers (i.e., numbers fitting a user's intended purpose) other than the predetermined numbers.

### SUMMARY OF THE INVENTION

In view of the foregoing, it is an object of the present invention to provide an improved audio apparatus which allows the numbers of mixing buses and matrix buses to be set as desired by a user.

In order to accomplish the above-mentioned object, the present invention provides an improved audio apparatus which performs at least first mixer processing for mixing audio signals from a plurality of input channels by means of a plurality of mixing buses and then outputting resultant mixed audio signals to a plurality of first output channels, and second mixer processing for mixing the audio signals from the first output channels by means of a plurality of matrix buses while treating the audio signals from the first output channels as inputs to the matrix buses and then outputting resultant mixed audio signals to a plurality of second output channels, the audio apparatus comprising: a digital signal processing section which is shared for performing the first mixer processing and the second mixer processing, the digital signal processing section performing each of the first mixer processing and the second mixer processing by performing cross-point processes each for performing level control on an input audio signal and then adding a resultant level-controlled audio signal to one or more of the buses, a total number of the cross-point processes executable by the digital signal processing section being limited; a setting section operable to set, in accordance with user operation, desired numbers of the mixing buses for use in the first mixer processing and the matrix buses for use in the second mixer processing; and a control section which controls setting, via the setting section, of the numbers of the mixing buses and the matrix buses in such a manner that a sum of a number of first cross-point processes required for the desired number of the mixing buses set via the setting section and a number of second cross-point processes required for the desired number of the matrix buses set via the setting section does not exceed a limit of the total number of the cross-point processes.

According to the present invention, any desired numbers, fitting a user's intended purpose, of the mixing buses and matrix buses can be set as long as the sum of the number of first cross-point processes required for the desired number of the mixing buses and the number of second cross-point processes required for the desired number of the matrix buses does not exceed the limit of the total number of the cross-point processes.

The present invention may be constructed and implemented not only as the apparatus invention as discussed above but also as a method invention. Also, the present invention may be arranged and implemented as a software program for execution by a processor such as a computer or DSP, as well as a storage medium storing such a software program. In this case, the program may be provided to a user in the storage medium and then installed into a computer of the user, or delivered from a server apparatus to a computer of a client via a communication network and then installed into the computer. Further, the processor used in the present invention may comprise a dedicated processor with dedicated logic built in hardware, not to mention a computer or other general-purpose type processor capable of running a desired software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

For better understanding of the object and other features of the present invention, its preferred embodiments will be described hereinbelow in greater detail with reference to the accompanying drawings, in which:

FIG. 1 is an overview block diagram showing a general setup of an audio apparatus according to an embodiment of the present invention;

FIG. 2 is a block diagram showing processing algorithms of a DSP and sound I/F in the audio apparatus of the present invention;

FIG. 3 is a diagram showing a construction equivalent to MIX buses in the audio apparatus of the present invention;

FIG. 4 is a diagram showing a construction equivalent to MTRX buses in the audio apparatus of the present invention;

FIG. 5 is a diagram showing a hardware construction equivalent to the DSP in the audio apparatus of the present invention;

FIG. 6 is a diagram showing an example of a setting screen displayed in the audio apparatus of the present invention;

FIG. 7 is a flow chart of a number-of-bus-channel change process performed in the audio apparatus of the present invention; and

FIG. 8 is a flow chart of a number-of-assigned-insert/direct out change process performed in the audio apparatus of the present invention.

### DETAILED DESCRIPTION

FIG. 1 is an overview block diagram showing a general setup of an audio apparatus according to an embodiment of the present invention. A CPU (Central Processing Unit) 10 in the audio apparatus 1 shown in FIG. 1 executes a management program (Operating System or OS) so that overall behavior of the audio apparatus 1 is controlled by the OS. The audio apparatus 1 includes a non-volatile ROM (Read-Only Memory) 12 having stored therein operating software, such as a mixing control program, to be executed by the CPU 10, and a RAM (Random Access Memory) 11 provided for storing various data and including a working area for the CPU 10. The CPU 10 executes the mixing control program so that mixing processing is performed on a plurality of input signals after audio signal processing is performed on the audio signals via a DSP (Digital Signal Processor) 13. Rewriting of the operating software is permitted by implementing the ROM 12 with a rewritable ROM, such as a flash memory, so that version upgrade of the operating software can be facilitated. Under control of the CPU 10, the DSP 13 performs digital signal processing for mixing input audio signals after adjusting tone volume levels and frequency characteristics of the audio signals on the basis of parameters set therefor, and controlling acoustic characteristics, such as tone volumes, panning characteristics and effects, of the audio signals on the basis of parameters set therefor.

A detection circuit 14 scans various controls (operators) 15, such as faders, knobs and switches, provided on an operation panel of the audio signal 1, to human operator's detect operation on the controls 15. Values of parameters to be used for the audio signal processing can be changed on the basis of operation detection signals output from the detection circuit 14. A display circuit 16 is provided for visually displaying various mixing-related screens on a display section 17 in the form of a liquid crystal display or the like. A communication I/F (interface) 18 is a networking interface, such as the Ethernet (registered trademark) interface, provided for communication with an external device 19 connected to the audio apparatus 1. A sound I/F 20 is a networking interface for communicating audio signals with microphones and speakers 21 that output and input audio signals. Audio signals input from the microphones 21 etc. via the sound I/F 20 are subjected to mixing etc. through the aforementioned digital signal processing by the DSP 13 are output via the speakers 21 oriented toward audience seats or the like. The aforementioned various components of the audio apparatus 1 communicate data with one another via a communication bus 22.

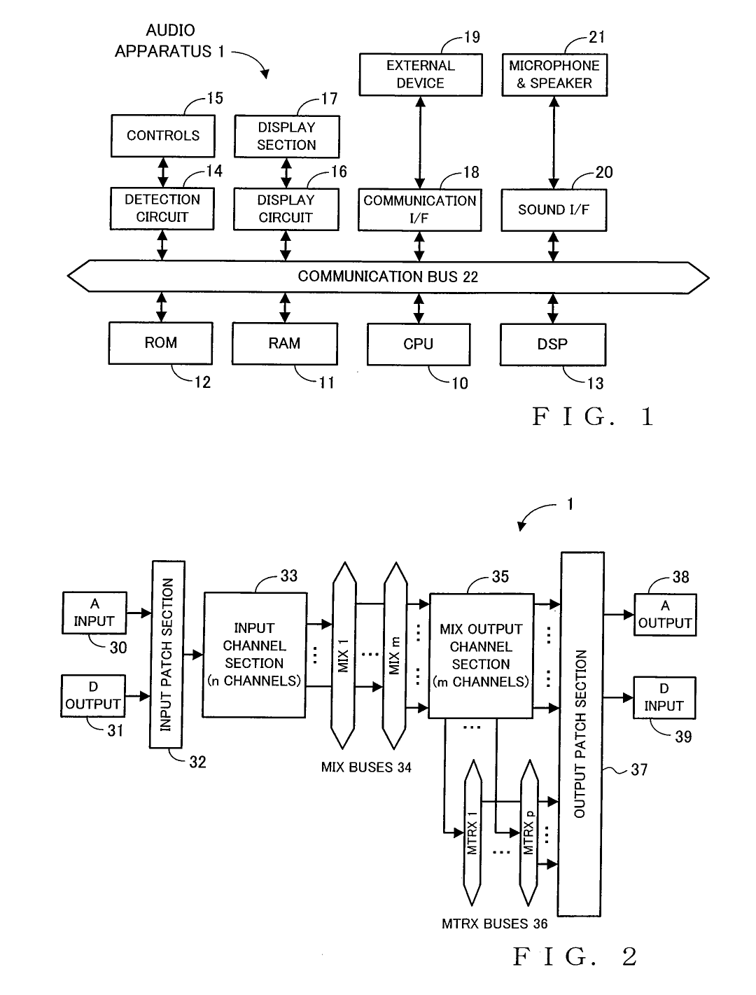

The following paragraphs describe processing algorithms of the DSP 13 and sound I/F 20 in the audio apparatus 1, with reference to FIG. 2.

In FIG. 2, a plurality of analog signals input to a plurality of analog input ports (A inputs) 30 are taken in via the sound I/F 20, converted into digital signals and supplied to an input patch section 32. A plurality of digital signals input to a plurality of digital input ports (D inputs) 31 are input directly to the input patch section 32. The input patch section 32 can patch (or couple) each one of the input ports, which are signal input sources, selectively to any one of n (n is a integral number) input channels of the input channel section 33; each of the input channels is supplied with a signal from any one of the input ports patched by the input patch section 32.

Characteristics of the audio signal of each of the input channels (also referred to as “input channel signal”) are adjusted by an equalizer (EQ) and compressor (Comp), but also a send level of the audio signal of each of the input channels (i.e., input channel signal) is controlled. Thus, the thus-adjusted and controlled audio signals of the input channels are sent to m (m is an integral number) mixing buses (hereinafter abbreviated as “MIX buses”) 34. In this case, each of the signals the n input channels output from the input channel section 32 is selectively sent to one or more of the m MIX buses 34. In each of the m MIX buses 34, one or more input audio signals selectively sent from one or more input channels are mixed together. Thus, a total of m different mixed outputs (audio signals) are supplied to first output channels of a MIX output channel section 35, so that signals of the m output channels (hereinafter also referred to as “first output channel signals”) mixed in m different ways are output.

Audio signal characteristics, such as frequency balance, of each of the first output channel signals are adjusted by an equalizer (EQ) and compressor (Comp). The first output channel signals of the m output channels from the MIX output channel section 35 are output to an output patch section 37, but also one or more of the first output channel signals of the m output channels are selectively sent to the inputs of p (p is an integral number) matrix buses (hereinafter abbreviated as “MTRX buses”) 36. In each of the p MTRX buses 36, one or more first output channel signals selectively input from any of the m output channels are mixed together. Thus, a total of p different mixed outputs are output to the output patch section 37. Outputs of the p MTRX buses 36 will hereinafter be referred to as “second output channels” or “sub-mixing output channels” or “sub-mixing, second output channels”. Thus, the MTRX buses 36 output sub-mixed signals by further mixing (i.e., sub-mixing) the signals, already mixed by the MIX buses 34, in p different ways. The sub-mixed signals may be used in the following cases. For example, in a concert hall where vocal tones, guitar tones, drum tones, . . . are output to Output Channel 1, Output Channel 2, Output Channel 3, . . . , respectively, of the first output channels of the MIX output channel section 35, audio signals produced by mixing together the vocal, guitar, drum tones etc. are preferred as audio signals to be audibly reproduced or sound through speakers provided in a lobby and hallway (corridor) of the concert hall. Thus, output channel signals of the vocal, guitar, drum, . . . may be mixed via the MTRX buses 36 so that sub-mix signals output from the MTRX buses 36 can be sounded through the speakers provided in the lobby and hallway of the concert hall.

The output patch section 37 can patch (couple) each one of the m first output channel signals from the MIX output channel section 35 and p sub-mix signals from the MTRX buses 36 selectively to any one of output ports of an analog output port (A output) section 38 and digital output port (D output) section 39; thus, a signal of any one of the signals, patched by the output patch section 37, is supplied to each of the output ports. Digital output signals supplied to the analog output port (A output) section 38, having a plurality of analog output ports, are converted into analog output signals and then output from the analog output ports. Then, the analog output signals output from the analog output port section 38 are amplified by amplifiers and sounded through a plurality of the speakers 21. Further, the analog output signals are supplied to in-ear monitors attached to the ears of human players (performers) and/or reproduced via stage monitor speakers provided near the human players. Further, the digital audio signals output from the digital output port (“D output”) section 39, including a plurality of digital output ports, are supplied to a recorder, DAT externally connected to the audio apparatus 1, and/or the like, so that they can be recorded in a digital manner.

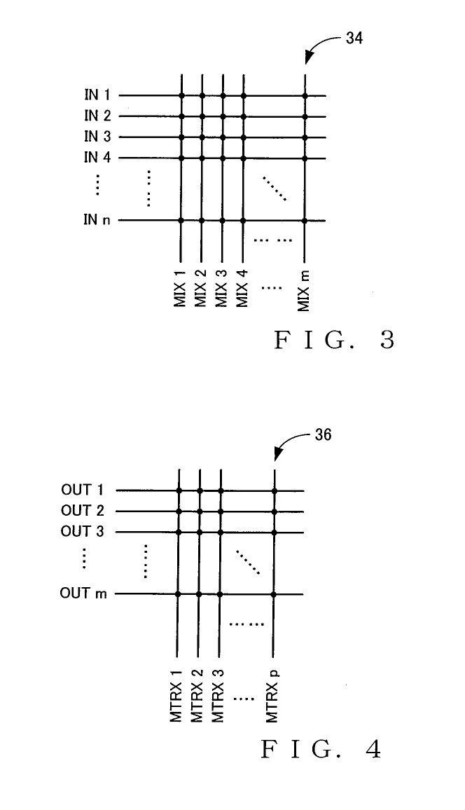

Mixer processing by the MIX buses 34 and sub-mix processing by the MTRX buses 36 are implemented by the DSP 13 executing microprograms. FIGS. 3 and 4 show the MIX buses 34 and MTRX buses 36 as equivalent hardware components.

FIG. 3 shows a construction equivalent to the MIX buses 34, where the MIX buses 34 comprise n row lines corresponding to the n input channels IN1, IN2, . . . , INn, and m column lines corresponding to the m MIX buses 34 MIX1, MIX2, . . . , and MIXm. Cross-point processes are performed at cross points (n×m) depicted at “” as intersecting points between the n row lines and the m column lines. For example, at the cross point between the row line IN1 and the column line MIX1, an input channel signal from the input channel IN1 is controlled in level by being multiplied by a coefficient, so that the level-controlled signal is added to a signal of the column line MIX1 to be output to the column line MIX1. A similar cross-point process is performed at each of the other cross points.

FIG. 4 shows a construction equivalent to the MTRX buses 36, where the MTRX buses 36 comprise m row lines corresponding to the m output channels OUT1, OUT2, . . . , OUTm, and p column lines corresponding to the p MTRX buses 36 MTRX1, MTRX2, . . . , and MTRXp. Cross-point processes are performed at cross points (m×p) depicted at “” as intersecting points between the m row lines and the p column lines. For example, at the cross point between the row line OUT1 and the column line MTRX1, an output channel signal from the output channel OUT1 is controlled in level by being multiplied by a coefficient, so that the level-controlled signal is added to a signal of the column line MTRX1 to be output to the column line MTRX1. A similar cross-point process is performed at each of the other cross points.

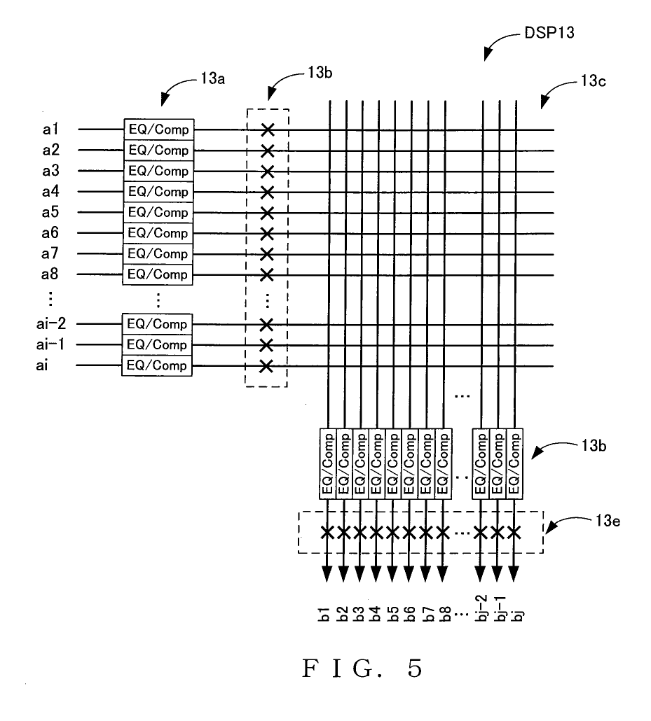

The DSP 13 is capable of performing (n×m) cross-point processes required for the MIX buses 34 and (m×p) cross-point processes required for the MTRX buses 36. FIG. 5 shows a hardware construction equivalent to the mixing processing performed by the DSP 13.

In the equivalent construction of the DSP 13 shown in FIG. 15, a matrix section 13c comprises i (i is an integral number) row lines a1, a2, a3, . . . , ai, and j (i is an integral number) column lines b1, b2, b3, . . . , bj. An EQ/Comp section 13a for performing an equalizer process and compressor process is provided for each of the i row lines, and similarly, an EQ/Comp section 13d for performing an equalizer process and compressor process is provided for each of the j column lines. At each of the (i×j) intersecting points of the matrix section 13c, a cross-point process comprising product-sum operations is performed. An insert processing section 13d for inserting an effect is provided in each of the i row lines, and similarly, an insert processing section 13e for inserting an effect is provided in each of the j column lines. Examples of the effect to be inserted here are reverberation and chorus effects; note that an effect imparting process is not performed by the DSP 13, but performed by another processing section provided in the audio apparatus 1.

Namely, the DSP 13 performs the cross-point process at each of the (i×j) intersecting points and a process of each of the EQ/Comp sections 13a and 13d. The number (i×j) of the cross-point processes is determined by the number of resources calculated by subtracting resources necessary for the EQ/Comp sections 13a and 13d from resources of the DSP 13, and the number of the cross-point processes that can be performed by the DSP 13 is limited with the number (i×j). Namely, the processes of the MIX buses 34 are implemented by the (n×m) cross-point processes being performed within the limited number (i×j), and the processes of the MTRX buses 36 are implemented by the remaining (m×p) cross-point processes being performed. Namely, the limited number (i×j) of the cross-point processes that can be performed by the DSP 13 are allocated to the MIX buses 34 and MTRX buses 36, i.e. a relationship of

“(i×j)≧(n×m)+(m×p)” (1)

is established. In this way, the number m of the MIX buses 34 and the number p of the MTRX buses 36 can be set as desired by the user within the limit satisfying the relationship or mathematical expression (1) described above.

Because the effect insert requires operations for sending an audio signal, being processed by the DSP 13, to another processing section and receiving from the other processing section the audio signal imparted with an effect, resources of the DSP 13 are used for performing the effect insert. Thus, resources corresponding to the number of input channels and output channels that perform the effect insert (function) are allocated from among resources corresponding to the number of currently-unused cross-point processes within the limited number (i×j) of cross-point processes.

As known, among the input channels are input channels having a direct out function, i.e. direct out input channels, whose audio signals are output directly to the output channels without being subjected to the mixer processing. Resources of the DSP 13 are used for executing such a direct out function. Thus, resources corresponding to the number of the direct out input channels are allocated from among resources corresponding to the number of currently-unused cross-point processes within the limited number (i×j) of cross-point processes.

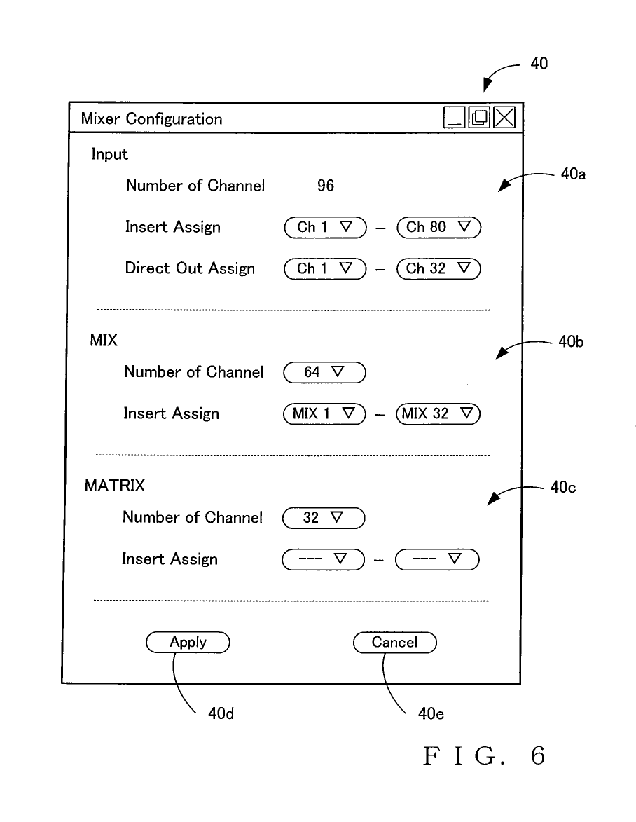

FIG. 6 shows an example of a setting screen 40 to be used by the human operator (user) for setting desired numbers of the MIX buses 34 and MTRX buses 36. The setting screen 40 includes an input channel setting area 40a labeled “Input”, an output channel setting area 40b labeled “MIX”, and a sub-mixing output channel setting area 40c labeled “MATRIX”. Per each of the setting areas 40a-40c, the human operator can designate channels, eight channels as a minimum unit, in a “From To” format in a list box of the area.

More specifically, in the input channel setting area 40a, the human operator can designate a desired number of the input channels and direct out input channels. In the illustrated example, the maximum number of the input channels (“Number of Channels”) is fixed at “96”, it is designated in an “Insert Assign” section that an effect insert function be assigned to eighty channels from Input Channel 1 to Input Channel 80 of the ninety-six input channels. Further, it is designated in a “Direct Out Assign” section that thirty-two channels from Input Channel 1 to Input Channel 32 perform a direct out function (i.e., function as direct out channels).

In the output channel setting area 40b of the setting screen 40, the human operator can designate a particular number of the first output channels for setting a desired number of the MIX buses 34 and a range of the output channels to which the effect insert function is to be assigned. In the illustrated example, the number of the output channels designated by the human operator is sixty-four (i.e., sixty-four MIX buses 34), and it is designated in an “Insert Assign” section that the effect insert function be assigned to thirty-two channels from Output Channel 1 to put Channel 32 of the sixty-four output channels (i.e., MIX1-MIX32).

Further, in the sub-mixing output channel setting area 40c of the setting screen 40, the human operator can designate a particular number of the sub-mixing, second output channels for setting a desired number of the MTRX buses 36 and a range of the sub-mixing output channels to which the effect insert function is to be assigned. In the illustrated example, the number of the sub-mixing, second output channels designated by the human operator is thirty-two (i.e., thirty-two MTRX buses 36), and the effect insert function is not assigned to any one of the sub-mixing, second output channels. Note that the total number of the first output channels (MIX buses 34) and sub-mixing, second output channels (MTRX buses 36) is limited to the maximum number “96” as noted above.

When the setting operation on the setting screen 40 has been completed, the settings can be established by the human operator clicking on an “Apply” button 40d. The settings can be cleared by the human operator clicking on a “Cancel” button 40e, so that the preceding or last settings can be restored.

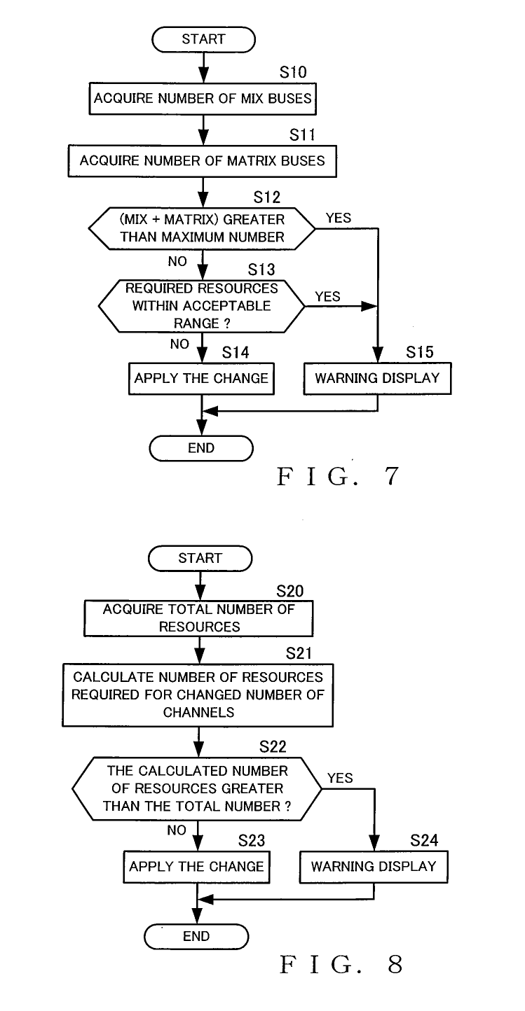

FIG. 7 is a flow chart of a number-of-bus-channel change process performed in response to human operator's operation performed on the setting screen 40 for changing the number of the first output channels or the sub-mixing, second output channels.

Once the human operator performs operation on the setting screen 40 for changing the number of the first output channels or the sub-mixing, second output channels, the number-of-bus-channel change process is started up. At step S10, a desired number of the MIX buses 34 is acquired with reference to the number of the output channels set in the “Number of Channel” section in the output channel setting area 40b labeled “MIX”. Then, at step S11, a desired number of the MTRX buses 36 is acquired with reference to the user-desired number of the output channels set in the “Number of Channel” section in the sub-mixing output channel setting area 40c labeled “MTRX”. After that, a determination is made, at step S12, as to whether a sum of the acquired numbers of the MIX buses 34 and MTRX buses 36 (MIX+MATRIX) is greater than (or exceeds) the maximum number of channels. If the sum (MIX+MATRIX) is not greater than the maximum number of channels (e.g., ninety-six) as determined at step S12, control proceeds to step S13.

At step S13, a determination is made as to whether resources of the DSP 13 required when the numbers of the MIX buses 34 and MTRX buses 36 are set as designated in the setting areas 40b and 40c, i.e. resources of the DSP 13 required for the desired numbers of the MIX buses 34 and MTRX buses 36, are within a predetermined acceptable range. Resources of the DSP 13 required in this case correspond in number to the cross-point processes to be used for the currently-set numbers of the first output channels and sub-mixing, second output channels; resources are also required for the above-mentioned channels for which the effect insert and direct out functions are to be executed. Specifically, a total number of resources of the DSP 13 is equal to a total number of steps of microprograms executable by the DSP 13 within one sampling period, and it can be represented by a total number (i.e., i×j) of the cross-point processes each requiring a plurality of steps. If the number of the required resources of the DSP 13 is not greater than (i.e., does not exceed) the total number of resources and is within the predetermined acceptable range as determined at step S13, control goes to step S14, where changed numbers of the first output channels and sub-mixing, second output channels are applied. Further, if the sum (MIX+MATRIX) is greater than (exceeds) the maximum number of channels as determined at step S12, or if the number of the required resources of the DSP 13 is greater than the total number of resources and exceeds the predetermined acceptable range as determined at step S13, control branches to step S15, where a warning display indicating that the sum (MIX+MATRIX) is greater than the maximum number of channels is made. The user is prompted by the warning display to re-designate or reset a desired number of the first output channels or sub-mixing, second output channels, and then re-designates or resets a desired number of the first output channels or sub-mixing, second output channels such that no warning display is made. Once the operation of step S14 or step S15 is completed, the instant number-of-bus-channel change process is brought to an end. Alternatively, at step S15, the setting value may be automatically changed, in place of or in addition to the warning display being made, in such a manner that the sum of the user-set numbers of the channels falls within the predetermined limit.

FIG. 8 is a flow chart of a number-of-assigned-insert/direct out change process performed in response to human operator's operation performed on the setting screen 40 for changing the number of channels to which the effect insert/direct out functions are to be assigned or for which the effect insert/direct out functions are to be performed.

Once the human operator performs operation on the setting screen 40 of FIG. 6 for changing the number of channels to which the effect insert/direct out functions are to be assigned or for which the effect insert/direct out functions are to be performed, the number-of-assigned-insert/direct out change process of FIG. 8 is started up. At step S20, the total number of resources is acquired. As noted above, the total number of resources is equal to the total number of steps of microprograms executable by the DSP 13 within one sampling period, and it can be represented by the total number of the cross-point processes each requiring a plurality of steps. At next step S21, the number of resources required for the changed number of channels to which the effect insert/direct out functions are to be assigned is calculated. The number of resources required for the changed number of channels can be calculated by adding, to the number of cross-point processes to be used for the designated numbers of output channels and sub-mixing output channel, the number of cross-points corresponding to the number of channels to which the effect insert/direct out functions are to be assigned. Then, a determination is made, at step S22, as to whether or not the number of resources calculated at step S21 is greater than (exceeds) the total number of resources. If the number of resources is not greater than the total number of resources as determined at step S22, control continues on to step S23, where the changed number of channels to which the effect insert/direct out functions are to be assigned is applied. If, on the other hand, the number of resources is greater than the total number of resources as determined at step S22, control branches to step S24, where a warning display indicating that the number of resources is greater than the total number of resources is made. Based on the warning display, the user re-designates a desired number of channels to which the effect insert/direct out functions are to be assigned such that no warning display is made. Once the operation of step S23 or step S24 is completed, the instant number-of assigned insert/direct out change process is brought to an end.

In the audio apparatus 1 of the present invention described above, the maximum number of cross-point processes is determined by the capability of the DSP provided in the audio apparatus 1, and the numbers of the output channels and sub-mixing output channels are set such that the sum of cross-point processes required for the mixing buses and matrix buses does not exceeds the maximum number of cross-point processes. In this way, the human operator (user) can set any desires numbers of the output channels and sub-mixing output channels as along as the number of the required cross-point processes does not exceed the predetermined limit. Thus, the user can set desires numbers of the mixing buses and matrix buses which fit a user's intended purpose.

The present application is based on, and claims priority to, Japanese Patent Application No. 2009-131900 filed on Jun. 1, 2009. The disclosure of the priority application, in its entirety, including the drawings, claims, and the specification thereof, is incorporated herein by reference.

What is claimed is:

1. An audio apparatus which performs at least first mixer processing for mixing audio signals from a plurality of input channels by means of a plurality of mixing buses and then outputting resultant mixed audio signals to a plurality of first output channels, and second mixer processing for mixing the audio signals from the first output channels by means of a plurality of matrix buses while treating the audio signals from the first output channels as inputs to the matrix buses and then outputting resultant mixed audio signals to a plurality of second output channels, said audio apparatus comprising:
a digital signal processing section which is shared for performing the first mixer processing and the second mixer processing, said digital signal processing section performing each of the first mixer processing and the second mixer processing by performing cross-point processes each for performing level control on an input audio signal and then adding a resultant level-controlled audio signal to one or more of the buses, a total number of the cross-point processes executable by said digital signal processing section being limited;
a setting section operable to set, in accordance with user operation, desired numbers of the mixing buses for use in the first mixer processing and the matrix buses for use in the second mixer processing; and
a control section which controls setting, via said setting section, of the numbers of the mixing buses and the matrix buses in such a manner that a sum of a number of first cross-point processes required for the desired number of the mixing buses set via said setting section and a number of second cross-point processes required for the desired number of the matrix buses set via said setting section does not exceed a limit of the total number of the cross-point processes.

2. The audio apparatus as claimed in claim 1, wherein said setting section is further capable of setting, in accordance with user operation, a number of an input channel for which a direct out function is to be performed to cause an audio signal from the input channel to be output directly to any one of the output channels without being subjected to the first mixer processing and a number of input and output channels for which en effect insert function is to be performed, and
wherein resources corresponding to a number of currently unused ones of the cross-point processes executable by said digital signal processing section can be used as resources required depending on the number of the channels for which the direct out and effect insert functions are to be performed.

3. The audio apparatus as claimed in claim 1, wherein said control section determines whether the sum of the number of first cross-point processes required for the desired number of the mixing buses set via said setting section and the number of second cross-point processes required for the desired number of the matrix buses set via said setting section exceeds the limit of the total number of the cross-point processes, and, when it has been determined that the sum exceeds the limit of the total number of the cross-point processes, said control section makes a warning display to prompt a user to perform input operation for resetting the numbers of the mixing and matrix buses.

4. The audio apparatus as claimed in claim 2, wherein said control section determines whether the sum of the number of first cross-point processes required for the desired number of the mixing buses set via said setting section and the number of second cross-point processes required for the desired number of the matrix buses set via said setting section exceeds the limit of the total number of the cross-point processes, and, when it has been determined that the sum exceeds the limit of the total number of the cross-point processes, said control section makes a warning display to prompt a user to perform input operation for resetting the numbers of the mixing and matrix buses.

5. A computer-implemented method for setting a number of buses for use in an audio apparatus,
the audio apparatus performing at least first mixer processing for mixing audio signals from a plurality of input channels by means of a plurality of mixing buses and then outputting resultant mixed audio signals to a plurality of first output channels and second mixer processing for mixing the audio signals from the first output channels by means of a plurality of matrix buses while treating the audio signals from the first output channels as inputs to the matrix buses and then outputting resultant mixed audio signals to a plurality of second output channels, the audio apparatus including a digital signal processing section which is shared for performing the first mixer processing and the second mixer processing, the digital signal processing section performing each of the first mixer processing and the second mixer processing by performing cross-point processes each for performing level control on an input audio signal and then adding a resultant level-controlled audio signal to one or more of the buses, a total number of the cross-point processes executable by said digital signal processing section being limited,
said method comprising:
a setting step of causing a user to set desired numbers of the mixing buses for use in the first mixer processing and the matrix buses for use in the second mixer processing; and
a step of controlling setting, via said setting step, of the numbers of the mixing buses and the matrix buses in such a manner that a sum of a number of first cross-point processes required for the desired number of the mixing buses set via said setting step and a number of second cross-point processes required for the desired number of the matrix buses set via said setting step does not exceed a limit of the total number of the cross-point processes.

6. A computer-readable storage medium containing a program to be executed by a computer for setting a number of buses for use in an audio apparatus,
the audio apparatus performing at least first mixer processing for mixing audio signals from a plurality of input channels by means of a plurality of mixing buses and then outputting resultant mixed audio signals to a plurality of first output channels and second mixer processing for mixing the audio signals from the first output channels by means of a plurality of matrix buses while treating the audio signals from the first output channels as inputs to the matrix buses and then outputting resultant mixed audio signals to a plurality of second output channels, the audio apparatus including a digital signal processing section which is shared for performing the first mixer processing and the second mixer processing, the digital signal processing section performing each of the first mixer processing and the second mixer processing by performing cross-point processes each for performing level control on an input audio signal and then adding a resultant level-controlled audio signal to one or more of the buses, a total number of the cross-point processes executable by said digital signal processing section being limited,
said program comprising:
a setting step of causing a user to set desired numbers of the mixing buses for use in the first mixer processing and the matrix buses for use in the second mixer processing; and
a step of controlling setting, via said setting step, of the numbers of the mixing buses and the matrix buses in such a manner that a sum of a number of first cross-point processes required for the desired number of the mixing buses set via said setting step and a number of second cross-point processes required for the desired number of the matrix buses set via said setting step does not exceed a limit of the total number of the cross-point processes.
